(19) United States
(12) Patent Application Publication
(10) Pub. No.: US 2012/0190794 A1
(43) Pub. Date: Jul. 26, 2012

(54) RELEASE AGENT, RELEASE MATERIAL, AND ADHESIVE TAPE

(75) Inventors: Tsuyoshi Hiramatsu, Ibaraki-shi (JP); Toru Iseki, Ibaraki-shi (JP)

(73) Assignee: NITTO DENKO CORPORATION, Ibaraki-shi, Osaka (JP)

(21) Appl. No.: 13/498,398

(22) PCT Filed: Sep. 28, 2010
(86) PCT No.: PCT/JP10/66849

§ 371 Date: Mar. 27, 2012

(30) Foreign Application Priority Data
Sep. 29, 2009 (JP) 2009-225416
Dec. 21, 2009 (JP) 2009-289740

(51) Int. Cl. C08L 75/06

(52) U.S. Cl. 525/124

(57) ABSTRACT

The present invention provides a release agent containing at least a nonreactive polyolefin, an aromatic isocyanate having 3 or more isocyanate groups in one molecule and a polyolefin polyol, wherein the content of the nonreactive polyolefin is not less than 80 wt %, and not less than 90 wt % of the nonreactive polyolefin has tensile elasticity at 23° C. of not more than 10 MPa and tensile fracture stress at 23° C. of not more than 8 MPa.

### TECHNICAL FIELD

The present invention relates to a release agent containing polyolefin, which is superior in adhesion to a substrate and has a peel force with low dependence on the peel rate, and a release material containing the agent, and also relates to an adhesive tape containing the release agent.

### BACKGROUND ART

A release material has a release agent layer on at least one surface of a substrate such as paper, plastic film, or plastic-laminated paper, and is used to protect adhesive surfaces of adhesive tapes, adhesive sheets, labels and the like, and is used in manufacturing processes for ceramic green sheets and the like.

The kind of release agent includes silicone-based release agent, long-chain alkyl-based release agent, polyolefin-based release agent, and fluorinated release agent, and they are used in distinct ways according to the use. Of these, silicone-based release agents are problematic in that they may cause corrosion and malfunctions when used for applications requiring precision such as those related to electronic components, and therefore, non-silicone-based release agents such as polyolefin-based release agents are used.

Release materials using a polyolefin-based release agent include those described in Patent Documents 1 to 3. Of these, Patent Documents 1 and 2 propose release materials prepared by applying a polyolefin dissolved in an organic solvent to a substrate, and drying the same. However, the release materials are problematic in the adhesion to a substrate, though a peel force corresponding to the inherent detachability of polyolefin is obtained, since the obtained release material shows easy exfoliation of the release agent layer when rubbed with fingertips and the like.

Patent Document 3 proposes a release material prepared by crosslinking a modified polyolefin having a functional group and an isocyanate-based crosslinking agent, and a release material concurrently using an unmodified polyolefin having no functional group, and describes that adhesion to a substrate is improved. However, the release materials used in patent documents 1-2, and patent document 3 are considered to contain a low density polyolefin as a release agent to achieve a light peel force. Release materials using such low density polyolefins mostly show high dependence of the peel force on the peel rate. When the peel rate is high, the peel force becomes high, which tends to degrade usability.

### DOCUMENT LIST

### Patent Documents

patent document 1: JP-A-55-152775
patent document 2: JP-A-6-99551
patent document 3: JP-A-2004-91776

### SUMMARY OF THE INVENTION

### Problems to be Solved by the Invention

In light of the above-mentioned situation, the problem to be solved by the present invention is to provide a release agent superior in adhesion to a substrate, which has a peel force with low dependence on the peel rate and a release material using the same, and further, an adhesive tape containing the release agent.

### Means of Solving the Problems

The present inventors have conducted intensive studies in an attempt to solve the aforementioned problems and found that a release material superior in adhesion to a substrate and having a peel force with low dependence on the peel rate can be obtained by applying, to a substrate, a release agent comprising at least a nonreactive polyolefin, an aromatic isocyanate having 3 or more isocyanate groups in one molecule and a polyolefin polyol, wherein the content of the nonreactive polyolefin is not less than 80 wt %, and not less than 90 wt % of the nonreactive polyolefin has tensile elasticity at 23° C. of not more than 10 MPa and tensile fracture stress at 23° C. of not more than 8 MPa, which resulted in the completion of the present invention.

Accordingly, the present invention provides the following.

[1] A release agent comprising at least a nonreactive polyolefin, an aromatic isocyanate having 3 or more isocyanate groups in one molecule and a polyolefin polyol, wherein the content of the nonreactive polyolefin is not less than 80 wt %, and not less than 90 wt % of the nonreactive polyolefin has tensile elasticity at 23° C. of not more than 10 MPa and tensile fracture stress at 23° C. of not more than 8 MPa.
[2] The release agent of the above-mentioned [1], wherein the aromatic isocyanate is an adduct of an aromatic diisocyanate with a polyvalent alcohol.
[3] The release agent of the above-mentioned [1] or [2], wherein the content of the aromatic isocyanate is 0.5-20 parts by weight relative to 100 parts by weight of the nonreactive polyolefin.
[4] The release agent of any one of the above-mentioned [1] to [3], wherein the polyolefin polyol has a number-average molecular weight of 1500-50000.
[5] A release material comprising a substrate and a release agent layer on at least one surface of the substrate, wherein the release agent layer comprises the release agent of any one of the above-mentioned [1] to [4].
[6] An adhesive tape comprising an adhesive layer and the release material of the above-mentioned [5] on at least one surface of the adhesive layer, wherein the adhesive layer is in contact with the release agent layer.
[7] An adhesive tape comprising a substrate, an adhesive layer on one surface of the substrate, and a release agent layer comprising the release agent of any one of the above-mentioned [1] to [4] on the other surface of the substrate.

### Effect of the Invention

The release agent of the present invention can realize a release material superior in adhesion to a substrate, which has a peel force that does not become excessively large even when the peel rate becomes fast and shows low dependence on the peel rate.

Therefore, using the release agent of the present invention, a release material and an adhesive tape, which are superior in the workability, can be obtained.

### DESCRIPTION OF EMBODIMENTS

### 1. Release Agent

The present invention provides a release agent comprising at least a nonreactive polyolefin, an aromatic isocyanate having 3 or more isocyanate groups (also referred to as “isocyanato group”) in one molecule and a polyolefin polyol, wherein the content of the nonreactive polyolefin is not less than 80 wt %, and not less than 90 wt % of the nonreactive polyolefin has tensile elasticity at 23° C. of not more than 10 MPa and tensile fracture stress at 23° C. of not more than 8 MPa.

### [Nonreactive Polyolefin]

The nonreactive polyolefin in the present invention is a polyolefin that does not react with the below-mentioned aromatic isocyanate and polyolefin polyol. For example, it is a polyolefin that does not contain a functional group (a hydroxyl group, an amino group, a carboxy group, an isocyanate group etc.) that reacts with aromatic isocyanate and polyolefin polyol. In the present invention, an unmodified polyolefin completely free of the aforementioned functional group is preferable, since heavy peeling may occur depending on the kind of the adhesive and the conditions of preservation in contact with an adhesive, even when the amount of the functional group is small.

In the present invention, the content of the nonreactive polyolefin in the release agent is not less than 80 wt %, preferably not less than 85 wt %, more preferably not less than 90 wt %. When the content of the nonreactive polyolefin in the release agent is less than 80 wt %, the detachability tends to be poor and the peel force tends to be high. While the upper limit of the content of the nonreactive polyolefin is not particularly limited, it is not more than 99 wt %, more preferably not more than 98 wt %, in order to obtain sufficient strength of the coated film.

The tensile elasticity at 23° C. and tensile fracture stress at 23° C. in the present invention are values measured by the following method.

Nonreactive polyolefin is dissolved in toluene to give 5-10 wt % solution, which is applied to a release film of a PET (poly(ethylene terephthalate)) substrate by using a Baker applicator or doctor blade type applicator. Immediately after drying by heating by a hot air dryer (100° C., 3 min), the substrate is cooled in 23° C. atmosphere to produce a nonreactive polyolefin film having a dried thickness of 20 μm. When solubility in toluene is poor, dissolution may accompany heating as necessary. The obtained nonreactive polyolefin film is cut out in the form of a rectangular strip of length 30 mm×width 100 mm. The nonreactive polyolefin film is tightly wound in longitudinal direction around one short side of the strip, while peeling the film off the release film to give a 30 mm-length rod-like sample.

This rod-like sample is subjected to a tensile test in 23° C. atmosphere under the conditions of chuck distance 10 mm and tensile speed 50 mm/min using a tensile tester (manufactured by Shimadzu Corporation, autograph AG-IS type) and a stress-strain curve at that time is obtained. The tensile elasticity is calculated from the inclination of the curve in the stress-strain curve immediately after the start of pulling. In addition, the stress upon breakage of the rod-like sample is determined as tensile fracture stress.

In the present invention, not less than 90 wt % (more preferably not less than 95 wt %, most preferably 100 wt %) of the nonreactive polyolefin contained in the release agent shows tensile elasticity at 23° C. of not more than 10 MPa (more preferably not more than 8 MPa, further preferably not more than 7 MPa, most preferably not more than 6 MPa), and tensile fracture stress at 23° C. of not more than 8 MPa (more preferably not more than 6 MPa, most preferably not more than 4 MPa). When the content of the nonreactive polyolefin is less than 90 wt %, the peel force by peeling at a low speed and/or the peel force by peeling at a high speed sometimes become(s) high due to an influence of other nonreactive polyolefin in the release agent, which does not satisfy the above-mentioned tensile elasticity and tensile fracture stress. When the tensile elasticity at 23° C. exceeds 10 MPa, the peel force by peeling at a low speed and/or the peel force by peeling at a high speed tend(s) to be high. When the tensile fracture stress at 23° C. exceeds 8 MPa, the peel force by peeling at a high speed becomes high and the peeling tends to be difficult.

While the lower limit of the tensile elasticity at 23° C. is not particularly limited, since sufficient strength of the coated film cannot be achieved when it is too small, it is not less than 2 MPa, more preferably not less than 3 MPa. Also, the lower limit of the tensile fracture stress at 23° C. is not particularly limited. However, since sufficient strength of the coated film cannot be achieved when the tensile fracture stress is too small, it is not less than 1 MPa, more preferably not less than 2 MPa.

While the nonreactive polyolefin in the present invention is not particularly limited as long as it meets the aforementioned requirements, for example, a nonreactive polyolefin capable of dissolving in an organic solvent together with other materials to permit application to a substrate is preferable, and a low density nonreactive polyolefin showing good solubility in organic solvents is preferably used. A release agent using a low density polyolefin generally affords light peeling, but often shows high dependence of the peel force on the peel rate. In the present invention, a nonreactive polyolefin having tensile elasticity at 23° C. of not more than 10 MPa and tensile fracture stress at 23° C. of not more than 8 MPa is mainly used. Therefore, even when destruction should occur near the interface between the adhesive layer and the release agent layer during peeling, the neighborhood of the interface can be destroyed with a small force since the tensile fracture stress is small, and even when the peel rate becomes fast, the peel force does not become too high, and the dependence of the peel force on the peel rate can be made small.

Specifically, nonreactive polyolefin having a density of not more than 0.885 g/cm³ is preferable, and nonreactive polyolefin having a density of not more than 0.880 g/cm³ is more preferable. When the density exceeds 0.885 g/cm³, the solubility in organic solvents decreases so that application to the substrate tends to be difficult, and so that the detachability tends to decrease. The lower limit is preferably 0.855 g/cm³ or more, since low density is associated with low melting point, as well as poor heat resistance, for example, in ethylene-based α-olefin copolymers.

Examples of such polyolefin having low density include α-olefin copolymer containing, as a monomer unit, at least two kinds selected from the group consisting of ethylene, propylene and α-olefin having a carbon number of 4-20. Of these, a copolymer containing ethylene as a principal monomer unit (that is, ethylene-based α-olefin copolymer) is preferable. Here, examples of the α-olefin having a carbon number of 4-20 include 1-butene, 1-pentene, 3-methyl-1-butene, 1-hexene, 4-methyl-1-pentene, 3-methyl-1-pentene, 1-heptene, 1-octene, 1-decene, 1-dodecene and the like. In addition, the α-olefin copolymer may be any of a random copolymer, a block copolymer and a graft copolymer, with preference given to a random copolymer since it shows good detachability.

Ethylene-based α-olefin copolymer preferably comprises 50 to 95 mol %, more preferably 70 to 95 mol %, of an ethylene unit; and one or more kinds selected from 1-butene, propylene, 1-hexene, and 1-octene are preferably used as a monomer unit other than ethylene. Particularly preferable copolymer includes ethylene-1-butene copolymer, ethylene-propylene copolymer and the like. Such ethylene-1-butene copolymer may contain a monomer unit derived from an α-olefin other than ethylene and 1-butene in an amount of not more than 10 mol %; and ethylene-propylene copolymer may contain a monomer unit derived from an α-olefin other than ethylene and propylene in an amount of not more than 10 mol %. Such a copolymer can be obtained by, for example, copolymerizing ethylene and an α-olefin using a catalyst consisting of a transition metal catalytic component (e.g., vanadium compounds, zirconium compounds) and an organic aluminum compound catalytic component so that the ethylene unit content in the copolymer will be as described above.

In addition, in the present invention, the α-olefin copolymer may be a commercially available product. As the ethylene-based α-olefin copolymer, for example, TAFMER P series, TAFMER A series (all manufactured by Mitsui Chemicals, Inc.), ENGAGE (manufactured by Dow Chemical Company) and the like are preferably used. Particularly, as ethylene-based α-olefin copolymer having tensile elasticity at 23° C. of not more than 10 MPa and tensile fracture stress at 23° C. of not more than 8 MPa, for example, TAFMER P-0080K, TAFMER P-0280, TAFMER A-35070S, TAFMER P-0680, TAFMER P-0180, TAFMER P-0480, TAFMER P-0275, TAFMER P-0775 (all manufactured by Mitsui Chemicals, Inc.) and the like are preferably used.

In the present invention, one or more kinds of nonreactive polyolefins can be used for controlling the peel force. When two or more kinds are used, polyolefins satisfying the aforementioned requirements of the tensile elasticity and tensile fracture stress may be used, or polyolefin satisfying the aforementioned requirements of the tensile elasticity and tensile fracture stress, and polyolefin not satisfying the requirements may be used in combination. Such polyolefin not satisfying the requirements includes 3 embodiments of polyolefin having tensile fracture stress of not more than 8 MPa and tensile elasticity of over 10 MPa, polyolefin having tensile elasticity of not more than 10 MPa and tensile fracture stress of over 8 MPa, and polyolefin having tensile elasticity of over 10 MPa and tensile fracture stress of over 8 MPa. Preferred is a polyolefin having tensile elasticity of not more than 10 MPa and tensile fracture stress of over 8 MPa. A polyolefin having tensile elasticity of over 10 MPa preferably has tensile elasticity of not more than 100 MPa, and a polyolefin having tensile fracture stress of over 8 MPa preferably has tensile fracture stress of not more than 35 MPa.

In the present invention, when only one kind of nonreactive polyolefin is used, the nonreactive polyolefin preferably meets the aforementioned requirements of the tensile elasticity and tensile fracture stress, and has MFR (melt flow rate) at 230° C. of not more than 100 g/10 min, more preferably not more than 70 g/10 min, further preferably not more than 50 g/10 min, particularly preferably not more than 10 g/10 min, in view of the strength of the coated film for forming a release agent layer.

In addition, when two or more kinds of nonreactive polyolefins are used, at least one kind of the nonreactive polyolefin meeting the requirements of the aforementioned tensile elasticity and tensile fracture stress preferably has MFR at 230° C. of not more than 100 g/10 min. In addition, the proportion of the nonreactive polyolefin having MFR of not more than 100 g/10 min is preferably not less than 10 wt %, more preferably not less than 50 wt %, of the entire nonreactive polyolefin. As long as this condition is satisfied, a polyolefin having MFR at 230° C. of more than 100 g/10 min can be used as other polyolefin meeting the requirements of the aforementioned tensile elasticity and tensile fracture stress, or as a polyolefin not meeting the requirements.

### [Aromatic Isocyanate]

The aromatic isocyanate in the present invention is used as a crosslinking ingredient. An aromatic isocyanate is preferable because better adhesion to a substrate is obtained than with an aliphatic isocyanate. From the viewpoint of the strength and heat resistance of the release agent layer, aromatic isocyanates having three or more isocyanate groups in one molecule are preferable. Such aromatic isocyanates having three or more isocyanate groups in one molecule include, for example, terminal-isocyanate-containing compounds obtained by reacting an excess amount of a diisocyanate compound such as tolylene diisocyanate, diphenylmethane diisocyanate, 1,5-naphthylene diisocyanate, tolidine diisocyanate, xylylene diisocyanate and tetramethylxylylene diisocyanate with a polyhydric alcohol (an adduct of an aromatic diisocyanate with a polyhydric alcohol) and the like. In particular, from the viewpoint of reactivity and adhesion to a substrate, an adduct of tolylene diisocyanate with a polyhydric alcohol can be preferably used. Polyhydric alcohols as mentioned herein include, for example, aliphatic polyhydric alcohols such as ethylene glycol, glycerin, trimethylol propane, pentaerythritol, ditrimethylol propane, and dipentaerythritol and the like.

These aromatic isocyanates are of low compatibility with nonreactive polyolefins, being compatible with the nonreactive polyolefins only to the extent that does not affect the detachability of the nonreactive polyolefins. Therefore, the aromatic isocyanates remaining incompatible with the nonreactive polyolefins are localized between the layer with the nonreactive polyolefin as the major ingredient and the substrate, which are largely contributory to the adhesion between the release agent layer and the substrate.

The content of the aromatic isocyanate is 0.5-20 parts by weight, preferably 1.0-15 parts by weight, more preferably 1.5-10 parts by weight, relative to 100 parts by weight of the nonreactive polyolefin. When the content is within these ranges, an adverse influence of short pot life and the like is not observed, and more superior adhesion to a substrate can be achieved.

### [Polyolefin Polyol]

While the polyolefin polyol in the present invention is to be reacted with an aromatic isocyanate, it is preferable that the polyol be well compatible with the nonreactive polyolefin.

For example, the number-average molecular weight (Mn) of the polyolefin polyol is 1500-50000, preferably 1500-5000, more preferably 1500-4000, most preferably 1500-3000.

When the number-average molecular weight (Mn) is within the above range, polyolefin polyol can be moderately dissolved in both a layer mainly containing a nonreactive polyolefin and a layer mainly containing aromatic isocyanate (i.e., a layer containing smaller amount of nonreactive polyolefin) in the release agent layer. Since polyolefin polyol having the aforementioned molecular weight can be moderately dissolved in the layer mainly containing a nonreactive polyolefin, the strength and heat resistance of the release agent layer can be improved, and a release agent layer having superior appearance, which is free of white cloud, can be obtained. In addition, since excess hydroxyl group due to polyolefin polyol does not occur in a layer mainly containing nonreactive polyolefin, a lightly peelable release agent layer can be obtained. Furthermore, in the layer mainly containing an aromatic isocyanate (i.e., a layer containing smaller amount of nonreactive polyolefin) in the release agent layer, aromatic isocyanate and polyolefin polyol can be reacted moderately, and more superior adhesion to a substrate can be obtained.

The kind of polyolefin polyol is not particularly limited. Examples thereof include polyethylene-based polyol, polypropylene-based polyol, polybutadiene polyol, hydrogenated polybutadiene polyol, polyisoprene polyol, hydrogenated polyisoprene polyol and the like. Of these, hydrogenated polyisoprene polyol and polyisoprene polyol are preferable, in view of the compatibility with polyolefin and influence on the peel force.

In addition, polyolefin polyol preferably has a hydroxyl value (mg KOH/g) of not less than 20, in view of the strength and hardenability of the coated film containing a release agent. Moreover, in view of the influence on the peel force, the hydroxyl value (mg KOH/g) is preferably not more than 75, more preferably 25-60.

In the present invention, the polyolefin polyol can be a commercially available product and, it includes for example, Poly bdR-45HT (hydroxyl-terminated liquid polybutadiene: Mn=2800, hydroxyl value=46.6 mg KOH/g, manufactured by Idemitsu Kosan Co., Ltd.), Poly ip (hydroxyl-terminated liquid polyisoprene: Mn=2500, hydroxyl value=46.6 mg KOH/g, manufactured by Idemitsu Kosan Co., Ltd.), Epole (hydroxyl-terminated liquid hydrogenated polyisoprene: Mn=2500, hydroxyl value=50.5 mg KOH/g, manufactured by Idemitsu Kosan Co., Ltd.), GI-1000 (hydroxyl group-containing liquid hydrogenated polybutadiene: Mn=1500, hydroxyl value=60-75 mg KOH/g, manufactured by Nippon Soda Co., Ltd.), GI-2000 (hydroxyl group-containing liquid hydrogenated polybutadiene: Mn=2100, hydroxyl value=40-55 mg KOH/g, manufactured by Nippon Soda Co., Ltd.), GI-3000 (hydroxyl group-containing liquid hydrogenated polybutadiene: Mn=3000, hydroxyl value=25-35 mg KOH/g, manufactured by Nippon Soda Co., Ltd.) and the like. All of these polyols are liquid at ordinary temperature. In addition, UNISTOLE P-801 (16% toluene solution of hydroxyl group-containing polyolefin, toluene-free product thereof is a solid, hydroxyl value 40 mg KOH/g, manufactured by Mitsui Chemicals, Inc.) can also be used.

In the present invention, the content of polyolefin polyol in the release agent is set such that the value of A in the following formula (formula 1) is 30-250, preferably 40-200, more preferably 50-150. When the value A is smaller than 30, the strength of the release agent layer tends to be insufficient, and when it is higher than 250, heavy peeling of the layer tends to occur.

A=hydroxyl value (mg KOH/g) of polyolefin polyol×parts by weight of polyolefin polyol relative to 100 parts by weight of polyolefin (Formula 1)

### [Urethane Catalyst]

In the present invention, a urethane catalyst may be used for the reaction of an aromatic isocyanate and a polyolefin polyol; useful urethane catalysts include catalysts for ordinary urethanization reactions. Urethane catalysts are exemplified by tin compounds such as dibutyltin dilaurate and dioctyltin dilaurate; carboxylates of metals such as zinc, cobalt, copper, and bismuth; amine compounds such as 1,4-diazabicyclo[2.2.2]octane; and chelate compounds of metals such as titanium and zirconium. Salts of bismuth with organic acid (salts of bismuth with alicyclic organic acids such as salts of bismuth with resin acids containing abietic acid, neoabietic acid, d-pimaric acid, iso-d-pimaric acid, or podocarpic acid, or a combination of two kinds or more thereof, as a main component; salts of bismuth with aromatic organic acids such as benzoic acid, cinnamic acid, and p-oxycinnamic acid; and the like) can also be used. In particular, from the viewpoint of compatibility with the release agent composition and urethanization reaction reactivity, dibutyltin dilaurate, dioctyltin dilaurate, salts of bismuth with carboxylic acids and salts of bismuth with resin acids are preferable.

The content of the urethane catalyst is preferably 0.05 to 2.0 parts by weight, more preferably 0.1 to 1.5 parts by weight, still more preferably 0.1 to 1.0 parts by weight, relative to 100 parts by weight of nonreactive polyolefin. When the content is less than 0.05 parts by weight, the catalytic effect is often insufficient; when the content exceeds 2.0 parts by weight, the catalyst is more likely to cause heavy peeling and troubles such as shortening of the pot life of the release agent in solution.

As mentioned here, the content of catalyst is expressed as parts by weight of active ingredient; for example, in the case of the solution type, prepared by dissolving an active ingredient compound like “PUCAT B7”, which is used in Examples below, in a solvent, the content means parts by weight of the active ingredient compound alone.

Where necessary, the release agent of the present invention may appropriately contain olefin-based resin other than the aforementioned nonreactive polyolefin, antioxidant, UV absorber, light stabilizer such as hindered amine light stabilizer and the like, antistatic agent, fillers such as carbon black, calcium oxide, magnesium oxide, silica, zinc oxide, titanium oxide etc., pigments, and the like.

### 2. Release Material

The present invention also provides a release material having a release agent layer comprised of the aforementioned release agent on at least one surface of a substrate.

### [Substrate]

Although the substrate in the present invention is not particularly limited, a plastic film is preferable because it has a smooth surface. Examples include polyester films such as poly(ethylene terephthalate) film and polybutylene terephthalate film and polyolefin films such as polyethylene film and polypropylene film. When paper such as craft paper, glassine paper, or fine paper is used as the substrate, preference is given to one laminated with a plastic such as polyethylene or sealed up in order to prevent any ingredient of the release agent from impregnating the substrate in excess.

The substrate may be subjected to a corona treatment, plasma treatment, flame treatment and the like in advance as necessary. The thickness of the substrate is not limited, and can be appropriately determined depending on the object of use. When a plastic film, it is generally about 12-250 μm, preferably 16-200 μm, more preferably 25-125 μm.

In addition, the substrate may appropriately contain, where necessary, antioxidant, UV absorber, light stabilizer such as hindered amine light stabilizer and the like, antistatic agent, fillers such as carbon black, calcium oxide, magnesium oxide, silica, zinc oxide, titanium oxide etc., pigments, and the like.

### [Release Agent Layer]

The release agent layer in the present invention is obtained by, for example, dissolving a composition that constitutes a release agent in a diluting solvent, applying the solution to a substrate, and then drying the solution. Although the solution concentration is not particularly limited, it is adjusted normally in the range of 0.1 to 5% by weight.

The diluting solvent is not particularly limited, as far as it is capable of homogeneously dissolving the release agent composition; however, because the release agent in the present invention has a polyolefin as the primary ingredient, it is preferable from the viewpoint of homogenous dissolution to mainly use a hydrocarbon-based solvent. Hydrocarbon-based solvents are exemplified by aliphatic hydrocarbon-based solvents such as normal hexane and normal heptane, alicyclic hydrocarbon-based solvents such as cyclohexane, and aromatic hydrocarbon-based solvents such as toluene and xylene. Furthermore, as required, ketones such as methyl ethyl ketone, cyclohexanone, and acetylacetone, esters such as ethyl acetate, alcohols such as methanol, ethanol, and isopropyl alcohol and the like may be used in combination.

For a method of applying the release agent to the substrate, conventionally-used methods such as kiss-roll coater, bead coater, rod coater, Mayer bar coater, die coater, gravure coater and the like can be utilized. While the drying method is not particularly limited, a most general method is hot air drying and, depending on the heat resistance of the substrate, a release agent layer can be obtained by drying at about 80-150° C.

The thickness of the release agent layer is preferably 30 to 500 nm, more preferably 45 to 400 nm, most preferably 60 to 300 nm. When the thickness of the release agent layer is less than 30 nm, heavy peeling may sometimes arise; when the thickness exceeds 500 nm, the layer may sometimes undergo blocking when wound in the form of a roll, or the peel force may sometimes increase.

In the release material, other layer may be formed between the release agent layer and the substrate. However, the release agent layer needs to be present on the outermost surface. The release agent layer is preferably directly formed on the substrate.

3. Adhesive Tape with Release Material

The present invention provides an adhesive tape having the above-described release material on at least one surface of an adhesive layer, wherein the adhesive layer is in contact with the release agent layer of the release material.

While an adhesive to be used for an adhesive layer of the adhesive tape is not particularly limited, rubber-based adhesives, acrylic adhesives, polyester-based adhesives and the like can be used. Of these, acrylic adhesives and polyester-based adhesives are preferable since they afford stable detachability.

An acrylic adhesive can be prepared by using an acrylic polymer obtained by a commonly used method of polymerization such as solution polymerization, emulsion polymerization, or UV polymerization as the principal agent, with various additives such as crosslinking agents, tackifiers, softening agents, antiaging agents, and fillers added thereto as required.

As the aforementioned acrylic polymer, a copolymer of a monomer mixture containing alkyl(meth)acrylate such as butyl(meth)acrylate, 2-ethylhexyl(meth)acrylate and the like as a main component, and, where necessary, other monomer as a copolymerizable modifying monomer (e.g., hydroxyl group-containing monomer such as 2-hydroxyethyl(meth)acrylate and the like, carboxyl group-containing monomer such as (meth)acrylic acid and the like, styrene-based monomer such as styrene and the like, vinyl esters such as vinyl acetate etc., and the like) can be used.

Examples of the polyester-based adhesive include an adhesive containing, as a base resin, a polyester-based polymer containing aliphatic carbonate diol (e.g., carbonate diol obtained by the reaction of a diol component such as butanediol and the like with a carbonate compound such as ethylenecarbonate and the like, and the like) as an inherent polyol component.

In addition, the adhesive layer can be formed by applying, for example, an adhesive solution to the release agent layer of the release material, and drying same. In addition, the thickness of the adhesive layer can be appropriately determined in consideration of the adhesiveness and the like, and is generally 3-100 μm, preferably 5-90 μm, more preferably 10-80 μm.

### 4. Adhesive Tape Having Release Agent Layer Comprising Release Agent

In addition, the present invention provides an adhesive tape having an adhesive layer on one surface of a substrate, and a release agent layer comprising the release agent of the present invention on the other surface (hereinafter to be referred to as “back coating layer”).

The adhesive tape of the present invention may assume any of a roll-like wound form and a stacked sheet form. In both forms, the adhesive layer can be protected by a back coating layer.

In the adhesive tape, the adhesive layer and the back coating layer may be directly formed on a substrate, and other layer may be formed between these layers and the substrate. However, both the adhesive layer and the back coating layer need to be present on the outermost surface. In this way, when the adhesive tape is wound like a roll, or the adhesive tape in a sheet form is laminated, the adhesive layer can be protected by the back coating layer in contact with the adhesive layer. Both the adhesive layer and the back coating layer are preferably directly formed on a substrate.

While the adhesive to be used for the adhesive tape of the present invention is not particularly limited, rubber-based adhesives, acrylic adhesives, polyester-based adhesives and the like can be used. Of these, acrylic adhesives and polyester-based adhesives are preferable, since stable detachability can be obtained.

A back coating layer can be formed by a method similar to that used for the aforementioned release agent layer, and the thickness of the back coating layer is preferably 30-500 nm, more preferably 45-400 nm, most preferably 60-300 nm, from the aspect of peel force.

### 5. Physical Properties, Characteristics and the Like

In the present specification, the physical property, characteristics and the like are measured by the following methods.

### (1) Density

A value measured according to ASTM D1505

### (2) Melt Flow Rate (230° C.)

A value measured according to ASTM D1238

### (3) Number-average Molecular Weight

A value measured according to ASTM D2503

### (4) Hydroxyl Value

A value measured according to JIS K1557

### EXAMPLES

The materials used in Examples and Comparative Examples are collectively described below.

In the following, “%” means “wt %” unless particularly described.

### <Nonreactive Polyolefin>

TABLE 1

| | | | tensile | tensile | |
|---|---|---|---|---|---|
| | | MFR | elas- | fracture | |
| | | (230° C.) | ticity | stress | density |
| polyolefin | polymer type | [g/10 min] | [MPa] | [MPa] | [g/cm³] |
| TAFMER | ethylene-propylene | 40 | 3.9 | 1.4 | 0.870 |
| P-0080K | random copolymer | | | | |
| | ethylene 87 mol % | | | | |
| | propylene 13 mol % | | | | |
| TAFMER | ethylene-propylene | 5.4 | 5.1 | 3.3 | 0.870 |
| P-0280 | random copolymer | | | | |
| | ethylene 87 mol % | | | | |
| | propylene 13 mol % | | | | |
| TAFMER | ethylene-1-butene | 65 | 3.5 | 2.1 | 0.870 |
| A-35070S | random copolymer | | | | |
| | ethylene 85 mol % | | | | |
| | 1-butene 15 mol % | | | | |
| TAFMER | ethylene-propylene | 0.7 | 6.2 | 7.0 | 0.870 |
| P-0680 | random copolymer | | | | |
| | ethylene 87 mol % | | | | |
| | propylene 13 mol % | | | | |
| TAFMER | ethylene-1-butene | 2.2 | 4.7 | 11.3 | 0.870 |
| A-1070S | random copolymer | | | | |
| | ethylene 85 mol % | | | | |
| | 1-butene 15 mol % | | | | |
| ENGAGE | ethylene-1-octene | 0.9 | 4.6 | 11.5 | 0.863 |
| 8180 | random copolymer | | | | |
| | ethylene 87 mol % | | | | |
| | 1-octene 13 mol % | | | | |
| TAFMER | ethylene-1-butene | 6.7 | 12.3 | 18.8 | 0.885 |
| A-4085S | random copolymer | | | | |
| | ethylene 92 mol % | | | | |
| | 1-butene 8 mol % | | | | |

TAFMER in Table 1 is manufactured by Mitsui Chemicals, Inc., and ENGAGE is manufactured by Dow Chemical Company.
The “tensile elasticity” and “tensile fracture stress” in Table 1 are values at 23° C.

### <Polyolefin Polyol>

Epole (hydroxyl-terminated liquid hydrogenated polyisoprene, Mn=2500, hydroxyl value 50.5 mg KOH/g, manufactured by Idemitsu Kosan Co., Ltd.)

UNISTOLE P-801 (16% toluene solution of hydroxyl group-containing polyolefin, toluene-free product thereof is solid, Mn>5000, hydroxyl value 40 mg KOH/g, manufactured by Mitsui Chemicals, Inc.)

### <Isocyanate>

CORONATE L (75% ethyl acetate solution of adduct of tolylene diisocyanate with trimethylolpropane, isocyanate group number in one molecule: 3, manufactured by Nippon Polyurethane Industry Co., Ltd.)

CORONATE HL (75% ethyl acetate solution of adduct of hexamethylenediisocyanate with trimethylolpropane, isocyanate group number in one molecule: 3, manufactured by Nippon Polyurethane Industry Co., Ltd.)

TAKENATE D110N (75% ethyl acetate solution of adduct of xylylene diisocyanate with trimethylolpropane, isocyanate group number in one molecule: 3, manufactured by Mitsui Chemicals, Inc.)

MILLIONATE MT (diphenylmethane diisocyanate, isocyanate group number in one molecule: 2, manufactured by Nippon Polyurethane Industry Co., Ltd.)

### <Urethane Catalyst>

dibutyltin dilaurate (manufactured by Wako Pure Chemical Industries, Ltd.)

PUCAT B7 (58% mineral spirit solution of bismuth resinate, manufactured by NIHON KAGAKU SANGYO CO., LTD.)

The release materials prepared in Examples and Comparative Examples were evaluated according to the following methods.

### (1) Adhesion of Release Agent Layer to Substrate

The surface coated with the release agent was rubbed with fingertips in 3 reciprocations and the surface was judged.

◯: Unchanged, or the surface becomes whitely clouded, but no dropout of coated film.
x: The coated film is dropped out in pieces to generate residues as if using a rubber eraser, causing the substrate to get exposed.

### (2) Low-speed Peel Force

The surface of the adhesive layer the acrylic adhesive tape No. 31B with 50 mm width (manufactured by NITTO DENKO CORPORATION) was laminated to the surface of the release agent layer of each release material using a hand roller to give an adhesive tape with a release material. After storage at 23° C. for 24 hours, this adhesive tape with a release material was pulled in a 180° direction at a speed of 0.3 m/min using a tensile tester, and a peel force measured in 23° C. atmosphere was taken as a low-speed peel force. The low-speed peel force in the present invention is preferably 0.10-0.30N/50 mm, and more preferably 0.10-0.25N/50 mm.

### (3) High-speed Peel Force

The peel force measured under the same conditions as the low-speed peel force except that the speed of pulling a release material was changed to 3 m/min was taken as a high-speed peel force. The high-speed peel force in the present invention is preferably 0.5-2.0N/50 mm, more preferably 0.5-1.5N/50 mm.

### (4) Dependence on Peel Rate

The dependence on peel rate is obtained by dividing the value of high-speed peel force by the value of low-speed peel force, and is preferably not more than 7, more preferably not more than 6, most preferably not more than 5, in the present invention.

### <Release Material>

### Example 1

TAFMER P-0280/Epole/CORONATE L/dibutyltin dilaurate=100/2/3/1 (weight ratio of solid content) was dissolved in toluene to give a release agent solution with a concentration of 1.5%. This release agent solution was applied to a 38 μm-thick polyester film with a mayer bar #6, and heated by a hot air dryers at 130° C.×1 min. The thickness of the release agent layer of the obtained release material is about 150 nm.

### Example 2

In the same manner as in Example 1 except that the composition of the release agent was set to TAFMER P-0280/Epole/CORONATE L/dibutyltin dilaurate=100/2/10/0.2 (weight ratio of solid content), a release material was prepared.

### Example 3

In the same manner as in Example 1 except that the composition of the release agent was set to TAFMER P-0280/TAFMER P-0080K/Epole/CORONATE L/dibutyltin dilaurate=60/40/1/5/0.2 (weight ratio of solid content), a release material was prepared.

### Example 4

In the same manner as in Example 1 except that the composition of the release agent was set to TAFMER P-0680/Epole/TAKENATE D110N/dibutyltin dilaurate=100/1/5/0.2 (weight ratio of solid content), a release material was prepared.

### Example 5

In the same manner as in Example 1 except that the composition of the release agent was set to TAFMER P-0280/TAFMER A-35070S/Epole/CORONATE L/PUCAT B7=80/20/2/3/0.6 (weight ratio of solid content), a release material was prepared.

### Example 6

In the same manner as in Example 1 except that the composition of the release agent was set to TAFMER P-0280/TAFMER A-1070S/Epole/CORONATE L/dibutyltin dilaurate=90/10/1/5/0.2 (weight ratio of solid content), a release material was prepared.

### Example 7

In the same manner as in Example 1 except that the composition of the release agent was set to TAFMER P-0280/TAFMER A-35070S/UNISTOLE P-801/CORONATE L/dibutyltin dilaurate=60/40/2/3/0.2 (weight ratio of solid content), a release material was prepared.

### Comparative Example 1

In the same manner as in Example 1 except that the composition of the release agent was set to TAFMER A-1070S/Epole/CORONATE HL/dibutyltin dilaurate=100/2/3/0.2 (weight ratio of solid content), a release material was prepared.

### Comparative Example 2

In the same manner as in Example 1 except that the composition of the release agent was set to ENGAGE 8180/Epole/CORONATE L/dibutyltin dilaurate=100/2/3/0.2 (weight ratio of solid content), a release material was prepared.

### Comparative Example 3

In the same manner as in Example 1 except that the composition of the release agent was set to TAFMER P-0280/TAFMER A-1070S/Epole/CORONATE L/dibutyltin dilaurate=80/20/1/5/0.2 (weight ratio of solid content), a release material was prepared.

### Comparative Example 4

In the same manner as in Example 1 except that the composition of the release agent was set to TAFMER A-1070S/Epole/CORONATE L/dibutyltin dilaurate=100/1/5/0.2 (weight ratio of solid content), a release material was prepared.

### Comparative Example 5

In the same manner as in Example 1 except that the composition of the release agent was set to TAFMER P-0280/Epole/CORONATE HL/dibutyltin dilaurate=100/2/3/0.2 (weight ratio of solid content), a release material was prepared.

### Comparative Example 6

In the same manner as in Example 1 except that the composition of the release agent was set to TAFMER P-0280/Epole/MILLIONATE MT/dibutyltin dilaurate=100/2/5/0.2 (weight ratio of solid content), a release material was prepared.

### Comparative Example 7

In the same manner as in Example 1 except that the composition of the release agent was set to TAFMER A-4085S/Epole/CORONATE L/dibutyltin dilaurate=100/2/3/0.2 (weight ratio of solid content), a release material was prepared.

### <Adhesive Tape>

The surface of the adhesive layer of 50 mm width acrylic adhesive tape No. 31B (manufactured by NITTO DENKO CORPORATION) was laminated on the surface of the release agent layer of each release material of Examples 1-7 and Comparative Examples 1-7 by using a hand roller to give adhesive tapes with a release material. Using the thus-prepared adhesive tapes, the aforementioned low-speed peel force and high-speed peel force were measured.

The evaluation results of the release materials prepared in the Examples and Comparative Examples are shown in Table 2.

TABLE 2

| | adhesion of | | | dependence |
|---|---|---|---|---|
| | release | low-speed | high-speed | on peel rate |
| | agent layer | peel force | peel force | (high speed/ |
| | to substrate | [N/50 mm] | [N/50 mm] | low speed) |
| Example 1 | ◯ | 0.20 | 0.88 | 4.4 |
| Example 2 | ◯ | 0.20 | 0.87 | 4.4 |
| Example 3 | ◯ | 0.18 | 0.81 | 4.5 |
| Example 4 | ◯ | 0.22 | 1.10 | 5.0 |
| Example 5 | ◯ | 0.18 | 0.85 | 4.7 |
| Example 6 | ◯ | 0.20 | 1.22 | 6.1 |
| Example 7 | ◯ | 0.19 | 0.94 | 4.9 |
| Comparative | X | 0.24 | 3.05 (X) | 12.7 (X) |
| Example 1 | | | | |
| Comparative | ◯ | 0.23 | 3.51 (X) | 15.3 (X) |
| Example 2 | | | | |
| Comparative | ◯ | 0.20 | 1.97 | 9.9 (X) |
| Example 3 | | | | |
| Comparative | ◯ | 0.23 | 2.90 (X) | 12.6 (X) |
| Example 4 | | | | |
| Comparative | X | 0.20 | 0.85 | 4.3 |
| Example 5 | | | | |
| Comparative | X | 0.20 | 0.89 | 4.5 |
| Example 6 | | | | |
| Comparative | ◯ | 0.36 (X) | 3.42 (X) | 11.0 (X) |
| Example 7 | | | | |

In Examples 1-7, release materials superior in the adhesion of a release agent to a substrate layer, and showing low dependence on the peel rate were obtained.

In contrast, in Comparative Examples 1 and 5 using aliphatic isocyanate, and Comparative Example 6 using aromatic isocyanate having less than 3 isocyanate groups in one molecule, the adhesion to a substrate was insufficient. In Comparative Examples 1, 2 and 4 using, as the nonreactive polyolefin, a nonreactive polyolefin having tensile fracture stress at 23° C. of over 8 MPa, the high-speed peel force was high and the dependence on peel rate was also high. Furthermore, in Comparative Example 3 using 20% of a nonreactive polyolefin having tensile fracture stress at 23° C. of over 8 MPa, the dependence on peel rate became high. Moreover, in Comparative Example 7 using, as the nonreactive polyolefin, a nonreactive polyolefin having tensile elasticity at 23° C. of over 10 MPa and tensile fracture stress at 23° C. of over 8 MPa, not only the high-speed peel force but also the low-speed peel force became high, and the dependence on peel rate also became high. Therefore, a release material simultaneously achieving both the adhesion to a substrate and dependence on peel rate could not be obtained in the Comparative Examples.

<Adhesive Tape with Back Coating Layer>

### (Preparation of Adhesive Solution)

2-Ethylhexyl acrylate (190 parts by weight), 2-hydroxyethyl acrylate (10 parts by weight), azobisisobutyronitrile (0.4 parts by weight) and ethyl acetate (372.2 parts by weight) as a polymerization solvent were placed in a separable flask, and the mixture was stirred for 1 hr while introducing a nitrogen gas. In this way, oxygen was removed from the polymerization system, and the mixture was heated to 63° C. and reacted for 10 hr to give a solution containing an acrylic polymer having a solid content of 35 wt %. The weight-average molecular weight of the acrylic polymer in this solution was one million.

Then, an isocyanate-based crosslinking agent (CORONATE L, manufactured by Nippon Polyurethane Industry Co., Ltd., 3 parts by weight) and a crosslinking promoter (EMBILIZER OL-1, manufactured by Tokyo Fine Chemical CO., LTD., 0.02 parts by weight) were added to 100 parts by weight of the aforementioned acrylic polymer, and the mixture was diluted with toluene to give an adhesive solution having a concentration of 25 wt %.

### (Preparation of Release Agent Solution)

TAFMER P-0280/Epole/CORONATE L/dibutyltin dilaurate=100/2/0.5/1 (weight ratio of solid content) was dissolved in toluene to give a release agent solution having a concentration of 1.0 wt %.

### (Preparation of Adhesive Tape)

The aforementioned release agent solution was applied to one surface of a 38 μm-thick polyester film by a kiss coater, and dried at 130° C. for 15 seconds to form a release agent layer having a dried thickness of 100 nm (back coating layer).

Then, the aforementioned adhesive was applied to the opposite surface of the obtained back coating layer by a reverse roll coater, and dried in 2 steps of 80° C.×15 seconds and then 130° C.×15 seconds to form an adhesive layer having a dried thickness of 25 μm. The tape was wound like a roll such that the adhesive layer was in the inner side to give an adhesive tape with a back coating layer.

The sequential steps from the formation of the release agent layer (back coating layer) to the formation of the adhesive layer and winding of the tape into a roll were performed at a line rate of 4 m/min.

The prepared adhesive tape could be rewound smoothly.

The present application is based on JP2009-225416 and JP2009-289740 filed in Japan, the contents of which are incorporated in full herein.

1. A release agent comprising at least a nonreactive polyolefin, an aromatic isocyanate having 3 or more isocyanate groups in one molecule and a polyolefin polyol, wherein the content of the nonreactive polyolefin is not less than 80 wt %, and not less than 90 wt % of the nonreactive polyolefin has tensile elasticity at 23° C. of not more than 10 MPa and tensile fracture stress at 23° C. of not more than 8 MPa.

2. The release agent according to claim 1, wherein the aromatic isocyanate is an adduct of an aromatic diisocyanate with a polyvalent alcohol.

3. The release agent according to claim 1, wherein the content of the aromatic isocyanate is 0.5-20 parts by weight relative to 100 parts by weight of the nonreactive polyolefin.

4. The release agent according to claim 1, wherein the polyolefin polyol has a number-average molecular weight of 1500-50000.

5. A release material comprising a substrate and a release agent layer on at least one surface of the substrate, wherein the release agent layer comprises the release agent according to claim 1.

6. An adhesive tape comprising an adhesive layer and the release material according to claim 5 on at least one surface of the adhesive layer, wherein the adhesive layer is in contact with the release agent layer.

7. An adhesive tape comprising a substrate, an adhesive layer on one surface of the substrate, and a release agent layer comprising the release agent according to claim 1 on the other surface of the substrate.
